(19) United States
(12) Patent Application Publication
(10) Pub. No.: US 2025/0139728 A1
(43) Pub. Date: May 1, 2025

(54) USER INTERFACE WITH ADAPTIVE MAP INDICATING LOCATIONS BASED ON PREDICTED BATCH VOLUME

(71) Applicant: Maplebear Inc., San Francisco, CA (US)

(72) Inventors: Roman Havran, Toronto (CA); Satish Kumar Reddy Kancherla, Dublin, CA (US); Chen Zhang, Campbell, CA (US); Sai Kannan Sampath, Berkeley, CA (US); Youdan Xu, Burlingame, CA (US); Yuan Gao, San Mateo, CA (US)

(21) Appl. No.: 18/498,445

(22) Filed: Oct. 31, 2023

(51) Int. Cl. G06Q 50/30; G01C 21/00; G06Q 30/0601

(52) U.S. Cl. CPC G06Q 50/40; G01C 21/3804; G06Q 30/0639

(57) ABSTRACT

A concierge system identifies retail locations within a distance of a picker client device of a picker. This distance defines a zone and the system provides a map of the zone for display within a picker client application. For each retail location in the zone, the system determines a batch volume for the retail location and an average batch volume for the zone and generates a batch availability score using a model trained on batch volumes for the retail location and batch volume for the zone. The batch availability score can be a value reflecting batch availability or busyness of the retail location relative to other retail locations or can be a wait time prediction in minutes until the picker receives a batch at the retail location. The system modifies how the retail locations are displayed on the map to emphasize those with batch availability scores above a threshold value.

### BACKGROUND

An online concierge system is an online system by which customers can order items to be delivered to them by a picker. An online concierge system may send pickers batches of orders that they are able to fulfill. Each batch of orders includes multiple orders with items to be collected from the same retail location. The picker reviews the batches received from the concierge system within a client application on their client device. The client application presents the batches in a list of available batches that the picker can accept. If the picker accepts a batch, the picker collects the items for the multiple orders at the retail location and delivers each order to its corresponding delivery location. Thus, pickers rely on batch availability to fulfill these orders and pickers waiting around near low volume retail locations is inefficient. However, the user interface of these picker applications do not effectively communicate batch availability based on different retail locations.

### SUMMARY

In accordance with one or more aspects of the disclosure, the concierge system identifies retail locations within a distance of a picker client device of a picker. This distance defines a zone and the concierge system provides a map of the zone for display within a picker client application. For each retail location in the zone, the concierge system determines a batch volume for the retail location and an average batch volume for the zone. With this information, the concierge system generates a batch availability score using a model trained on batch volumes for the retail location and batch volume for other retail locations in the zone. The batch availability score can be a numerical value reflecting batch availability or busyness of the retail location relative to other retail locations in the zone or can be a waiting prediction in minutes that corresponds to a waiting time until the picker receives a batch at the retail location. Accordingly, the concierge system modifies how the retail locations appear on the map to emphasize retail locations with a batch availability score above a batch availability score threshold value.

The concierge system, in one or more embodiments, can modify the appearance of retail locations displayed on the map by changing the color, such as by displaying those retail locations with batch availability scores below the threshold in greyscale or in faded colors relative to those with batch availability scores above the threshold. Alternatively, each retail location can be displayed with a number icon or graphic adjacent to the retail location on the map representing the predicted number of minutes until a batch becomes available at that retail location. Additionally, the concierge system, in one or more embodiments, may provide a batch availability user interface element or toggle for display within the shopper client application that, when selected by a picker, causes retail locations with a batch availability score below the batch availability score threshold value to be hidden from view on the map. Thus, modifying the appearance of the retail locations displayed on the map, in one or more embodiments, includes removing retail locations with a batch availability score below the batch availability score threshold value.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIGS. 3A-3B illustrate an example batch availability user interface element for display within a picker client application that, when selected, causes retail locations with a low batch availability to be removed from the map, in accordance with one or more embodiments.

FIG. 4 illustrates an example map displayed within a picker client application that has been modified to emphasize retail locations with a batch availability scores above a threshold value, in accordance with one or more embodiments.

FIG. 5 illustrates another example map displayed within a picker client application that has been modified to emphasize retail locations with a batch availability scores above a threshold value, in accordance with one or more embodiments.

FIG. 6 is a flowchart for a method of modifying the appearance of a map to emphasize retail locations based on batch volume, in accordance with one or more embodiments.

FIG. 7 is a flowchart for another method of modifying a map to emphasize retail locations based on batch volume, in accordance with one or more embodiments.

### DETAILED DESCRIPTION

### Overview

Shoppers, or pickers within the online concierge system ecosystem, rely on batch availability at retail locations to fulfill orders. Thus, pickers waiting around near low batch volume retail locations is inefficient. Accordingly, a method to predict batch availability and a user interface to direct pickers from locations of lower batch availability to locations of higher batch availability is disclosed. To this end, the online concierge system provides a picker client application through which pickers can identify orders to fulfill for different retail locations from a picker client device. Through the picker client application, the concierge system obtains the location of the picker and identifies retail locations within a threshold distance of the picker's location. This threshold distance defines a zone and the concierge system provides a map of at least a portion of the zone for display on the picker's client device through the picker client application. For each retail location in the zone, the concierge system determines a batch volume for the retail location and an average batch volume for the zone. Using this information as input to a machine learning model, the concierge system generates a batch availability score for each retail location in the zone. The batch availability score can be a numerical value reflecting batch availability or busyness of the retail location relative to other retail locations in the zone or can be a waiting time prediction in minutes corresponding to the predicted time the picker would need to wait at the retail location to receive a new batch.

Accordingly, the concierge system modifies or adjusts how the retail locations appear on the map to emphasize retail locations with a batch availability score above a batch availability score threshold value to encourage pickers to move towards busier retail locations. Encouraging pickers to move or wait near busier retail locations reduces customer wait times by getting the customers their orders more quickly and benefits the pickers by providing them with more batch deliveries per unit of time.

### An Online Concierge System

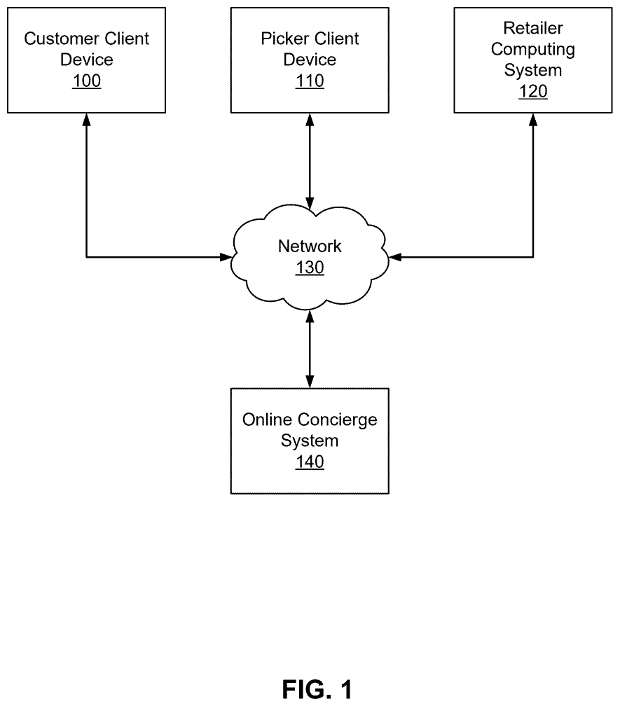

FIG. 1 illustrates an example system environment for online concierge system 140, in accordance with one or more embodiments. The system environment illustrated in FIG. 1 includes customer client device 100, picker client device 110, retailer computing system 120, network 130, and online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of online concierge system 140. Additionally, while one customer client device 100, picker client device 110, and retailer computing system 120 are illustrated in FIG. 1, any number of customers, pickers, and retailers may interact with online concierge system 140. As such, there may be more than one customer client device 100, picker client device 110, or retailer computing system 120.

Customer client device 100 is a client device through which a customer may interact with picker client device 110, retailer computing system 120, or online concierge system 140. Customer client device 100 can be a personal or mobile computing device, such as a smartphone, a tablet, a laptop computer, or desktop computer. In some embodiments, customer client device 100 executes a client application that uses an application programming interface (API) to communicate with online concierge system 140.

A customer uses customer client device 100 to place an order with online concierge system 140. An order specifies a set of items to be delivered to the customer. An “item,” as used herein, means a good or product that can be provided to the customer through online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

Customer client device 100 presents an ordering interface to the customer. The ordering interface is a user interface that the customer can use to place an order with online concierge system 140. The ordering interface may be part of a client application operating on customer client device 100. The ordering interface allows the customer to search for items that are available through online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

Customer client device 100 may receive additional content from online concierge system 140 to present to a customer. For example, customer client device 100 may receive coupons, recipes, or item suggestions. Customer client device 100 may present the received additional content to the customer as the customer uses customer client device 100 to place an order (e.g., as part of the ordering interface).

Additionally, customer client device 100 includes a communication interface that allows the customer to communicate with a picker that is servicing the customer's order. This communication interface allows the user to input a text-based message to transmit to picker client device 110 via network 130. Picker client device 110 receives the message from customer client device 100 and presents the message to the picker. Picker client device 110 also includes a communication interface that allows the picker to communicate with the customer. Picker client device 110 transmits a message provided by the picker to customer client device 100 via network 130. In some embodiments, messages sent between customer client device 100 and picker client device 110 are transmitted through online concierge system 140. In addition to text messages, the communication interfaces of customer client device 100 and picker client device 110 may allow the customer and the picker to communicate through audio or video communications, such as a phone call, a voice-over-IP call, or a video call.

Picker client device 110 is a client device through which a picker may interact with customer client device 100, retailer computing system 120, or online concierge system 140. Picker client device 110 can be a personal or mobile computing device, such as a smartphone, a tablet, a laptop computer, or desktop computer. In some embodiments, picker client device 110 executes a client application that uses an application programming interface (API) to communicate with online concierge system 140.

Picker client device 110 receives orders from online concierge system 140 for the picker to service. A picker services an order by collecting the items listed in the order from a retailer. Picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retail location. The collection interface further presents instructions that the customer may have included related to the collection of items in the order. Additionally, the collection interface may present a location of each item in the retail location, and may even specify a sequence in which the picker should collect the items for improved efficiency in collecting items. In some embodiments, picker client device 110 transmits to online concierge system 140 or customer client device 100 which items the picker has collected in real time as the picker collects the items.

The picker can use picker client device 110 to keep track of the items that the picker has collected to ensure that the picker collects all of the items for an order. Picker client device 110 may include a barcode scanner that can determine an item identifier encoded in a barcode coupled to an item. Picker client device 110 compares this item identifier to items in the order that the picker is servicing, and if the item identifier corresponds to an item in the order, picker client device 110 identifies the item as collected. In some embodiments, rather than or in addition to using a barcode scanner, picker client device 110 captures one or more images of the item and determines the item identifier for the item based on the images. Picker client device 110 may determine the item identifier directly or by transmitting the images to online concierge system 140. Furthermore, picker client device 110 determines a weight for items that are priced by weight. Picker client device 110 may prompt the picker to manually input the weight of an item or may communicate with a weighing system in the retail location to receive the weight of an item.

When the picker has collected all of the items for an order, picker client device 110 instructs a picker on where to deliver the items for a customer's order. For example, picker client device 110 displays a delivery location from the order to the picker. Picker client device 110 also provides navigation instructions for the picker to travel from the retail location to the delivery location. Where a picker is servicing more than one order, picker client device 110 identifies which items should be delivered to which delivery location. Picker client device 110 may provide navigation instructions from the retail location to each of the delivery locations. Picker client device 110 may receive one or more delivery locations from online concierge system 140 and may provide the delivery locations to the picker so that the picker can deliver the corresponding one or more orders to those locations. Picker client device 110 may also provide navigation instructions for the picker from the retail location from which the picker collected the items to the one or more delivery locations.

In some embodiments, picker client device 110 tracks the location of the picker as the picker delivers orders to delivery locations. Picker client device 110 collects location data and transmits the location data to online concierge system 140. Online concierge system 140 may transmit the location data to customer client device 100 for display to the customer such that the customer can keep track of when their order will be delivered. Additionally, online concierge system 140 may generate updated navigation instructions for the picker based on the picker's location. For example, if the picker takes a wrong turn while traveling to a delivery location, online concierge system 140 determines the picker's updated location based on location data from picker client device 110 and generates updated navigation instructions for the picker based on the updated location.

In one or more embodiments, the picker is a single person who collects items for an order from a retail location and delivers the order to the delivery location for the order. Alternatively, more than one person may serve the role as a picker for an order. For example, multiple people may collect the items at the retail location for a single order. Similarly, the person who delivers an order to its delivery location may be different from the person or people who collected the items from the retail location. In these embodiments, each person may have a picker client device 110 that they can use to interact with online concierge system 140.

Additionally, while the description herein may primarily refer to pickers as humans, in some embodiments, some or all of the steps taken by the picker may be automated. For example, a semi- or fully-autonomous robot may collect items in a retail location for an order and an autonomous vehicle may deliver an order to a customer from a retail location.

Retailer computing system 120 is a computing system operated by a retailer that interacts with online concierge system 140. As used herein, a “retailer” is an entity that operates a “retail location,” which is a store, warehouse, or other building from which a picker can collect items. Retailer computing system 120 stores and provides item data to online concierge system 140 and may regularly update online concierge system 140 with updated item data. For example, retailer computing system 120 provides item data indicating which items are available at a retail location and the quantities of those items. Additionally, retailer computing system 120 may transmit updated item data to online concierge system 140 when an item is no longer available at the retail location. Additionally, retailer computing system 120 may provide online concierge system 140 with updated item prices, sales, or availabilities. Additionally, retailer computing system 120 may receive payment information from online concierge system 140 for orders serviced by online concierge system 140. Alternatively, retailer computing system 120 may provide payment to online concierge system 140 for some portion of the overall cost of a user's order (e.g., as a commission).

Customer client device 100, picker client device 110, retailer computing system 120, and online concierge system 140 can communicate with each other via network 130. Network 130 is a collection of computing devices that communicate via wired or wireless connections. Network 130 may include one or more local area networks (LANs) or one or more wide area networks (WANs). Network 130, as referred to herein, is an inclusive term that may refer to any or all of standard layers used to describe a physical or virtual network, such as the physical layer, the data link layer, the network layer, the transport layer, the session layer, the presentation layer, and the application layer. Network 130 may include physical media for communicating data from one computing device to another computing device, such as MPLS lines, fiber optic cables, cellular connections (e.g., 3G, 4G, or 5G spectra), or satellites. Network 130 also may use networking protocols, such as TCP/IP, HTTP, SSH, SMS, or FTP, to transmit data between computing devices. In some embodiments, network 130 may include Bluetooth or near-field communication (NFC) technologies or protocols for local communications between computing devices. Network 130 may transmit encrypted or unencrypted data.

Online concierge system 140 is an online system by which customers can order items to be provided to them by a picker from a retailer. Online concierge system 140 receives orders from a customer client device 100 through network 130. Online concierge system 140 selects a picker to service the customer's order and transmits the order to a picker client device 110 associated with the picker. The picker collects the ordered items from a retail location and delivers the ordered items to the customer. Online concierge system 140 may charge a customer for the order and may provide portions of the payment from the customer to the picker and the retailer.

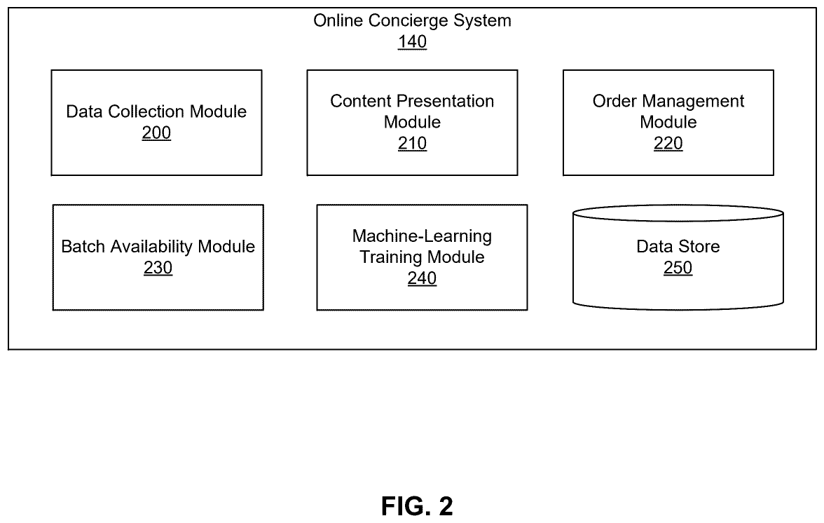

As an example, online concierge system 140 may allow a customer to order groceries from a grocery store retailer. The customer's order may specify which groceries they want delivered from the grocery store and the quantities of each of the groceries. The customer's client device 100 transmits the customer's order to online concierge system 140 and online concierge system 140 selects a picker to travel to the grocery store retail location to collect the groceries ordered by the customer. Once the picker has collected the groceries ordered by the customer, the picker delivers the groceries to a location transmitted to picker client device 110 by online concierge system 140. Online concierge system 140 is described in further detail below with regards to FIG. 2.

### Example Concierge System Architecture

FIG. 2 illustrates an example system architecture for online concierge system 140, in accordance with some embodiments. The system architecture illustrated in FIG. 2 includes data collection module 200, content presentation module 210, order management module 220, batch availability module 230, machine learning training module 240, and data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

Data collection module 200 collects data used by online concierge system 140 and stores the data in data store 250. Data collection module 200 may only collect data describing a user if the user has previously explicitly consented to online concierge system 140 collecting data describing the user. Additionally, data collection module 200 may encrypt all data, including sensitive or personal data, describing users.

For example, data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retail location, payment instrument, delivery location, or delivery timeframe. Data collection module 200 may collect the customer data from sensors on customer client device 100 or based on the customer's interactions with online concierge system 140.

Data collection module 200 also collects item data, which is information or data that identifies and describes items that are available at a retail location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retail locations. For example, for each item-retailer combination (a particular item at a particular warehouse), the item data may include a time that the item was last found, a time that the item was last not found (a picker looked for the item but could not find it), the rate at which the item is found, or the popularity of the item. Data collection module 200 may collect item data from a retailer computing system 120, a picker client device 110, or customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by online concierge system 140 (e.g., using a clustering algorithm).

Data collection module 200 also collects picker data, which is information or data that describes characteristics of pickers. For example, the picker data for a picker may include the picker's name, the picker's location, how often the picker has services orders for online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). Data collection module 200 collects picker data from sensors of picker client device 110 or from the picker's interactions with online concierge system 140.

Additionally, data collection module 200 collects order data, which is information or data that describes characteristics of an order. For example, order data may include item data for items that are included in the order, a delivery location for the order, a customer associated with the order, a retail location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

Content presentation module 210 selects content for presentation to a customer. For example, content presentation module 210 selects which items to present to a customer while the customer is placing an order. Content presentation module 210 generates and transmits the ordering interface for the customer to order items. Content presentation module 210 populates the ordering interface with items that the customer may select for adding to their order. In some embodiments, content presentation module 210 presents a catalog of all items that are available to the customer, which the customer can browse to select items to order. Content presentation module 210 also may identify items that the customer is most likely to order and present those items to the customer. For example, content presentation module 210 may score items and rank the items based on their scores. Content presentation module 210 displays the items with scores that exceed some threshold (e.g., the top n items or the p percentile of items).

Content presentation module 210 may use an item selection model to score items for presentation to a customer. An item selection model is a machine learning model that is trained to score items for a customer based on item data for the items and customer data for the customer. For example, the item selection model may be trained to determine the likelihood that the customer will order the item. In some embodiments, the item selection model uses item embeddings describing items and customer embeddings describing customers to score items. These item embeddings and customer embeddings may be generated by separate machine learning models and may be stored in data store 250.

In some embodiments, content presentation module 210 scores items based on a search query received from customer client device 100. A search query is text for a word or set of words that indicate items of interest to the customer. Content presentation module 210 scores items based on the relatedness of the items to the search query. For example, content presentation module 210 may apply natural language processing (NLP) techniques to the text in the search query to generate a search query representation (e.g., an embedding) that represents characteristics of the search query. Content presentation module 210 may use the search query representation to score candidate items for presentation to a customer (e.g., by comparing a search query embedding to an item embedding).

In some embodiments, content presentation module 210 scores items based on a predicted availability of an item. Content presentation module 210 may use an availability model to predict the availability of an item. An availability model is a machine learning model that is trained to predict the availability of an item at a retail location. For example, the availability model may be trained to predict the likelihood that an item is available at a retail location or may predict an estimated number of items that are available at a retail location. Content presentation module 210 may weigh the score for an item based on the predicted availability of the item. Alternatively, content presentation module 210 may filter out items from presentation to a customer based on whether the predicted availability of the item exceeds a threshold.

Order management module 220 that manages orders for items from customers. Order management module 220 receives orders from a customer client device 100 and assigns the orders to pickers for service based on picker data. For example, order management module 220 assigns an order to a picker based on the picker's location and the location of the retail location from which the ordered items are to be collected. Order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, order management module 220 determines when to assign an order to a picker based on a delivery timeframe requested by the customer with the order. Order management module 220 computes an estimated amount of time that it would take for a picker to collect the items for an order and deliver the ordered item to the delivery location for the order. Order management module 220 assigns the order to a picker at a time such that, if the picker immediately services the order, the picker is likely to deliver the order at a time within the timeframe. Thus, when order management module 220 receives an order, order management module 220 may delay in assigning the order to a picker if the timeframe is far enough in the future.

When order management module 220 assigns an order to a picker, order management module 220 transmits the order to picker client device 110 associated with the picker. Order management module 220 may also transmit navigation instructions from the picker's current location to the retail location associated with the order. If the order includes items to collect from multiple retail locations, order management module 220 identifies the retail locations to the picker and may also specify a sequence in which the picker should visit the retail locations.

Order management module 220 may track the location of the picker through picker client device 110 to determine when the picker arrives at the retail location. When the picker arrives at the retail location, order management module 220 transmits the order to picker client device 110 for display to the picker. As the picker uses picker client device 110 to collect items at the retail location, order management module 220 receives item identifiers for items that the picker has collected for the order. In some embodiments, order management module 220 receives images of items from picker client device 110 and applies computer-vision techniques to the images to identify the items depicted by the images. Order management module 220 may track the progress of the picker as the picker collects items for an order and may transmit progress updates to customer client device 100 that describe which items have been collected for the customer's order.

In some embodiments, order management module 220 tracks the location of the picker within the retail location. Order management module 220 uses sensor data from picker client device 110 or from sensors in the retail location to determine the location of the picker in the retail location. Order management module 220 may transmit to picker client device 110 instructions to display a map of the retail location indicating where in the retail location the picker is located. Additionally, order management module 220 may instruct picker client device 110 to display the locations of items for the picker to collect, and may further display navigation instructions for how the picker can travel from their current location to the location of a next item to collect for an order.

Order management module 220 determines when the picker has collected all the items for an order. For example, order management module 220 may receive a message from picker client device 110 indicating that all the items for an order have been collected. Alternatively, order management module 220 may receive item identifiers for items collected by the picker and determine when all of the items in an order have been collected. When order management module 220 determines that the picker has completed an order, order management module 220 transmits the delivery location for the order to picker client device 110. Order management module 220 may also transmit navigation instructions to picker client device 110 that specify how to travel from the retail location to the delivery location, or to a subsequent retail location for further item collection. Order management module 220 tracks the location of the picker as the picker travels to the delivery location for an order, and updates the customer with the location of the picker so that the customer can track the progress of their order. In some embodiments, order management module 220 computes an estimated time of arrival for the picker at the delivery location and provides the estimated time of arrival to the customer.

In some embodiments, order management module 220 facilitates communication between customer client device 100 and picker client device 110. As noted above, a customer may use a customer client device 100 to send a message to picker client device 110. Order management module 220 receives the message from customer client device 100 and transmits the message to picker client device 110 for presentation to the picker. The picker may use picker client device 110 to send a message to customer client device 100 in a similar manner.

Order management module 220 coordinates payment by the customer for the order. Order management module 220 uses payment information provided by the customer (e.g., a credit card number or a bank account) to receive payment for the order. In some embodiments, order management module 220 stores the payment information for use in subsequent orders by the customer. Order management module 220 computes a total cost for the order and charges the customer that cost. Order management module 220 may provide a portion of the total cost to the picker for servicing the order, and another portion of the total cost to the retailer.

Batch availability module 230 is a machine learning (ML) model trained to predict the availability of batches for a future period of time. In one or more embodiments, the model periodically computes a store-specific score that indicates batch availability or busyness of a retail location relative to other retail locations in a particular area or zone. In other embodiments, the model periodically predicts a waiting time that a picker would need to wait at a retail location to receive a new batch. In one or more embodiments, batch availability model 230 is ML supervised reinforcement logistic regression model with manual guardrails. The guardrails, in one or more embodiments, define a low batch volume retail location, for example, as 1) having a late percentage less than 10% and 2) having an average batch wait time of less than 15 min after a picker arrives at the retail location.

Accordingly, inputs to batch availability module 230 may include a predicted gap between picker supply and picker demand at each retail location and the predicted gap for other retail locations in the zone, average batch volume at each retail location and for the zone, the time it takes for a batch to be accepted by a picker (time to acceptance (TTA)) for the retail location and for the zone, the number of orders or batches over a past period of time (e.g., 2 hours) for the retail location and for the zone, the number of orders or batches at the same time over the past week for the retail location and for the zone, historical picker waiting times to receiving a batch at the retail location and for the zone, and so forth. Additionally, the inputs may include the number of pickers currently available online in the zone and/or the number of pickers currently available online within a threshold distance of the retail location, and so forth. In various embodiments, data for predicted high order volume retail locations, such as Costco, is excluded since it may skew or misrepresent picker demand in the zone for other retail locations. However, a predicted list of high order volume retail locations can be used to understand the relative demand of a potentially “low order volume” retail location in the zone.

With these inputs, batch availability module 230 may output a numerical score (e.g., between 0 and 1) reflecting the busyness of a specific retail location relative to other retail locations in the zone. Alternatively, the output of batch availability module 230 can be a numerical value in minutes predicting the time until the picker receives a batch at that retail location. The batch availability scores, in various embodiments, are regularly updated and refreshed (e.g., every 10 minutes) to reflect changes in activity or demand. Accordingly, for retail locations with a batch availability score above a threshold value, concierge system 140 modifies or adjusts how the retail locations appear on the map to emphasize those retail locations and encourage pickers to move towards and wait for batches at these busier retail locations.

Machine learning training module 240 trains machine learning models used by online concierge system 140. Online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. Machine learning training module 240 generates the set of parameters for a machine learning model by “training” the machine learning model. Once trained, the machine learning model uses the set of parameters to transform inputs into outputs.

Machine learning training module 240 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

Machine learning training module 240 may apply an iterative process to train a machine learning model whereby machine learning training module 240 trains the machine learning model on each of the set of training examples. To train a machine learning model based on a training example, machine learning training module 240 applies the machine learning model to the input data in the training example to generate an output. Machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. Machine learning training module 240 updates the set of parameters for the machine learning model based on the score generated by the loss function. For example, machine learning training module 240 may apply gradient descent to update the set of parameters.

Additionally, machine learning training module 240 may update or retrain the various ML models including batch availability module 230, in various embodiments. In one example, the models are updated on a regular basis, such as each day or week, using data from the past 90 days, for example. With respect to batch availability module 230, for example, an additional user interface element can be provided for each retail location that allows a picker to unhide the retail location if it has been removed from the map for having a low batch availability score. This interaction data where the picker unhides the retail location can be used to learn the pickers preferences. Moreover, information that a picker unhide a retail location and subsequently received a batch in a shorter period of time than predicted by concierge system 140 can be used as input to retain the model. Concierge system 140 can either use this to adjust the determined wait time prediction or it may be used to adjust a filtering threshold when filtering based on time to batch.

In another example, machine learning training module 240 may incorporate tracking data that shows how many stores are visible versus how many hidden in a zone and adjust the thresholds for hiding retail locations to ensure that a sufficient number of retail locations are visible at a given time.

Data store 250 stores data used by online concierge system 140. For example, data store 250 stores customer data, item data, order data, and picker data for use by online concierge system 140. Data store 250 also stores trained machine learning models trained by machine learning training module 240. For example, data store 250 may store the set of parameters for a trained machine learning model on one or more non-transitory, computer-readable media. Data store 250 uses computer-readable media to store data, and may use databases to organize the stored data.

### Example User Interfaces for Modifying a Map Based on Batch Availability

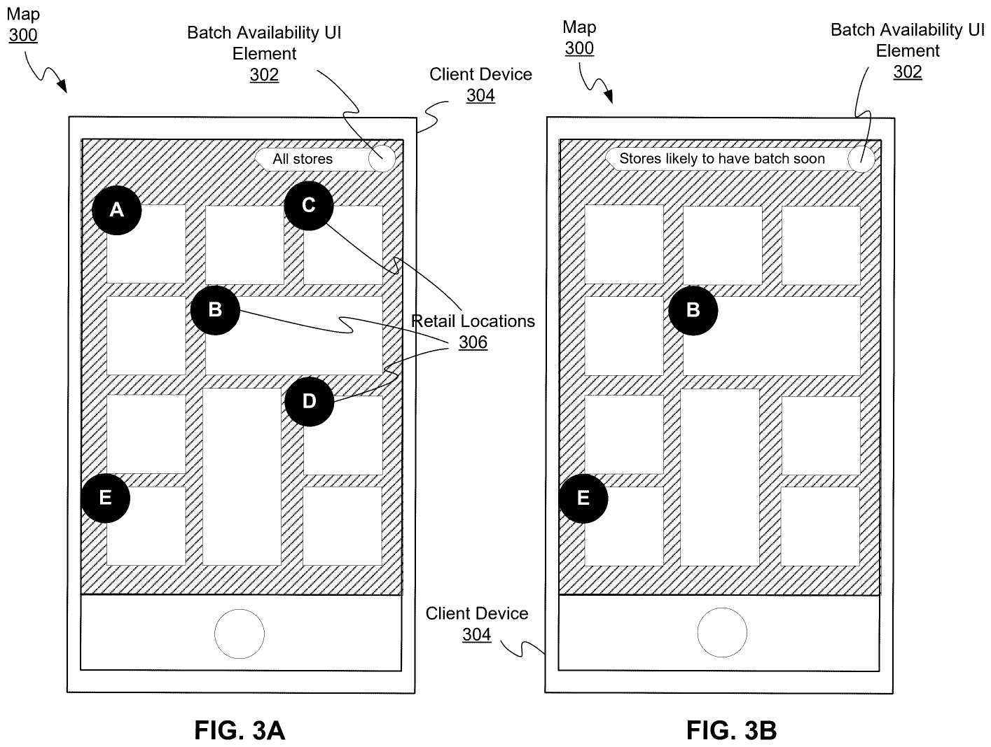

FIGS. 3A-3B illustrate an example batch availability user interface element for display within a picker client application that, when selected, causes retail locations with a low batch availability to be removed from the map, in accordance with one or more embodiments. FIG. 3A shows map 300 displayed with batch availability user interface (UI) element 302 on client device 304. Map 300, in various embodiments, is displayed by a client application provided by online concierge system 140 that has been downloaded by a picker onto their client device 304. In various embodiments, client device 304 is picker client device 110 described in connection with FIG. 1.

Upon opening the client application, concierge system 140 receives a location of client device 304 and identifies retail locations 306 within a distance of the picker's location. This distance is used to define a zone that corresponds to which retail locations are to be presented to the picker on map 300. The distance could be a predetermined distance from client device 304 (e.g., 5-20 miles), associated with a commute time (e.g., a distance within 15 min drive of the picker's location in current traffic), or associated with a zoom level of the map (e.g., concierge system 140 identifies more retail locations for the picker as the picker zooms out). In this example, map 300 shows retail locations 306 that are individually represented as retail locations A, B, C, D, and E.

FIG. 3A additionally shows batch availability UI element 302 that, when selected by the picker, removes retail locations from map 300 with a batch availability score below a particular value (i.e. a threshold value) to emphasize busier retail locations or those retail locations that are likely to have a batch available soon. In this context, a busy retail location is one where there is a gap between picker supply and picker demand (i.e., there are more batches for delivery than there are pickers to deliver them within a specified timeframe). In this example, batch availability UI element 302 is presented with a label indicating that all stores are currently being displayed.

FIG. 3B shows map 300 after the picker has selected batch availability UI element 302 and a subset of retail locations 306 (i.e., the less busy retail locations) have been removed from map 300. In this example, only retail locations B and E remain and batch availability UI element 302 provides an indication that these stores (i.e., retail locations B and E) are likely to have a batch soon.

To predict batch availability, concierge system 140 obtains the location of the picker and identifies retail locations 306 within a threshold distance of the picker's location. For each retail location 306 in the zone, concierge system 140 determines a batch volume for each retail location 306 and an average batch volume for all retail locations 306 in the zone, among other potential inputs described elsewhere herein. Using this information as input to a ML model, concierge system 140 generates the batch availability score for each retail location in the zone. Accordingly, retail locations 306 with a batch availability score of less than a threshold value are removed from map 300 in FIG. 3B and only retail locations B and E remain, thus, providing the picker with a visual representation of the highest volume retail locations 306 in their vicinity.

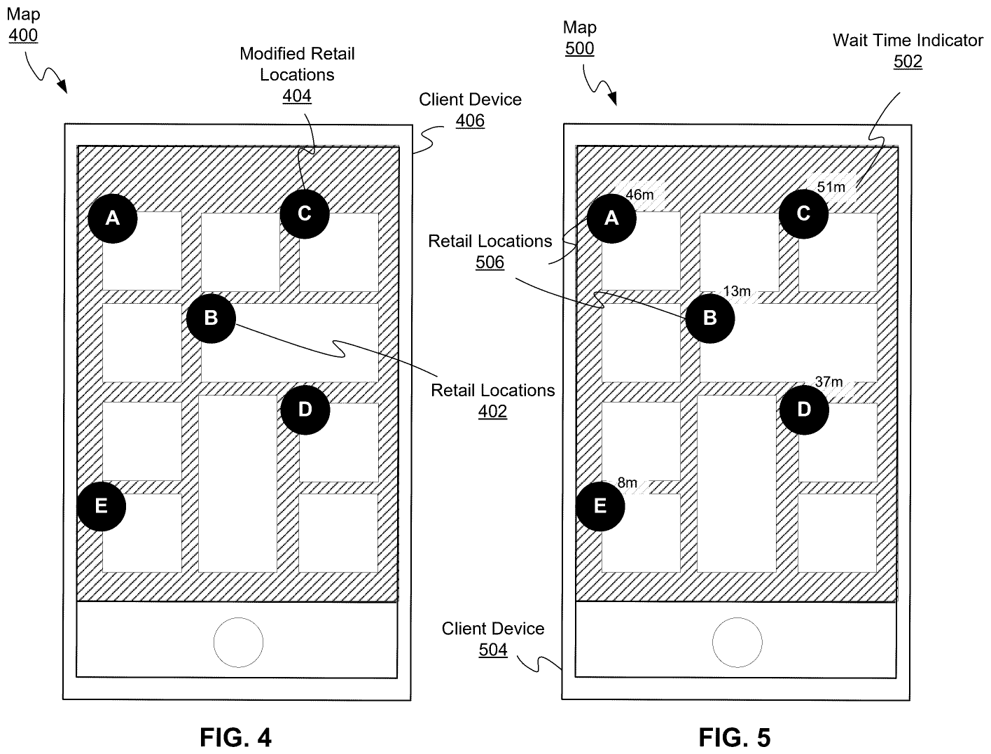

FIG. 4 illustrates another example map 400 displayed within a picker client application that has been modified to emphasize retail locations with a batch availability scores above a threshold value, in accordance with one or more embodiments. FIG. 4 shows map 400 with retail locations 402 and modified retail locations 404 on client device 406. In this example, there is no UI element or toggle and retail locations with a batch availability score below the threshold value are automatically visually adjusted in map 400 to emphasize busy retail locations 402 (i.e., retail locations B and E) and to deemphasize less busy modified retail locations 404 (i.e., retail locations A, C, and D). The automatic visual adjustment can be an optional setting or a system default. Thus, in this example, modified retail locations 404 have batch availability scores that are less than the threshold value and their appearance has been modified or adjusted to indicate their less busy status to the picker. The appearance modification can take the form of a color adjustment, such as displaying modified retail locations 404 in dull, faded, or greyscale colors relative to busier retail locations 402. Additionally, the modification can be to the busy retail locations 402 instead, as well as other means for visually differentiating busy retail locations 402 relative to less busy modified retail locations 404.

FIG. 5 illustrates another example map 500 displayed within a picker client application that has been modified to emphasize retail locations with a batch availability scores above a threshold value, in accordance with one or more embodiments. FIG. 5 shows map 500 with retail locations 506 presented by client device 504 where each retail location 506 is presented with a wait time indicator 502 adjacent to the location of retail location 506 on map 500. As described above, concierge system 140 determines a batch volume for each retail location 506 (among other potentially other inputs) and provides this information as input to ML batch availability model 230 to generate the batch availability score for each retail location in the zone. In this example, the batch availability score is a waiting time prediction in minutes corresponding to the predicted time the picker would hypothetically need to wait at the corresponding retail location to receive a new batch.

Accordingly, the predicted wait time for each retail location is displayed in map 500 adjacent to the retail location in wait time indicator 502 icon or graphic. Consistent with the previous examples of FIGS. 3-4, retail locations A, C, D are the less busy retail locations with wait times ranging from 37 to 51 minutes. These would not be efficient locations for a picker to wait at to receive a new batch. Retail locations B and E, however, have wait times of less than 15 minutes (i.e., the wait time for retail location B is 13 minutes and retail location E is 8 minutes). Thus, in this example, wait time indicator 502 is provided to emphasize the busier retail locations, with the added benefit of giving pickers an idea of how long they should expect to wait at a particular retail location 506 before receiving a batch. This further allows pickers to weigh whether they want to travel to a retail location with a lower wait time (that involves taking time to drive to the location) or to wait near a retail location close to their current location that has a relatively longer wait time but that obviates the need to travel.

### Methods for Modifying a Map to Emphasize Retail Locations Based on Batch Volume

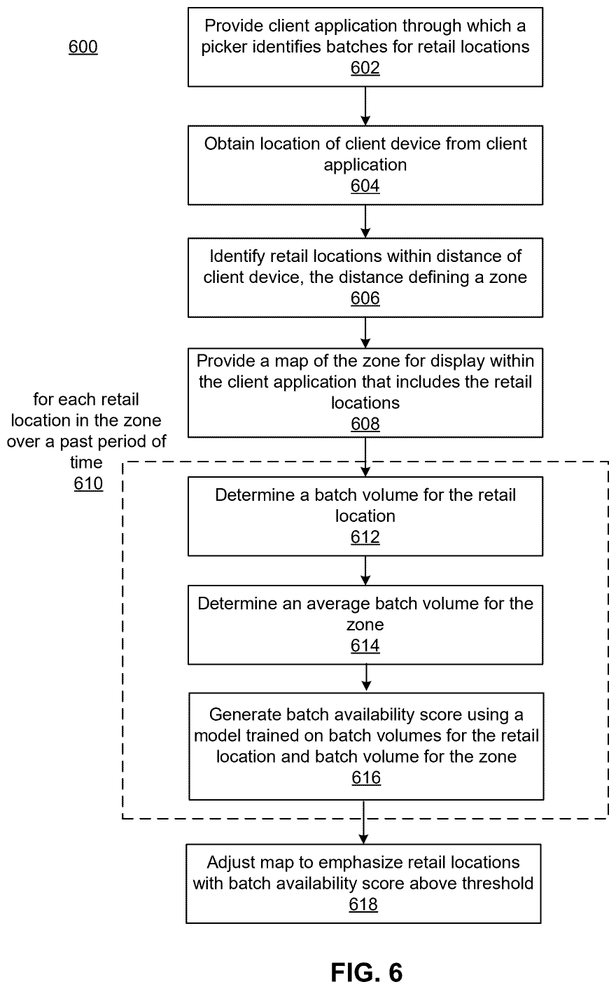

FIG. 6 is a flowchart for a method 600 of modifying a map to emphasize retail locations based on batch volume, in accordance with some embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention.

In this example, online concierge system 140 provides 602 a client application through which a picker can identify batches to fulfill for different retail locations from their client device. Each batch of orders includes multiple orders with items from individual customers to be collected from the same retail location. The picker reviews the batches received from the concierge system within the client application that presents the batches in a list of available batches that the picker can accept. If the picker accepts a batch, the picker collects the items for the multiple orders at the retail location and delivers each order to its corresponding delivery location. Thus, pickers rely on batch availability to fulfill these orders and pickers waiting around near low volume retail locations is inefficient.

Accordingly, concierge system 140 obtains 604 the location of client device from the client application and identifies 606 retail locations within a threshold distance of client device. The threshold distance from the location of the picker client device defines a zone. In various embodiments, the zone could encompass a predetermined distance from the client device, be associated with a commute time from the picker's current location, or be associated with a current zoom level of the map.

Concierge system 140 provides 608 a map of the zone for display within the client application that includes the retail locations. Based on the size of the zone and the current zoon level from which the picker is viewing the map, only a subset of the retail locations may be simultaneously displayed.

For each retail location 610 in the zone over a past period of time (e.g., past two hours, past week, same hour period at the same time last week, etc.), concierge system 140 determines 612 a batch volume for the retail location and, in some embodiments, additionally determines 614 an average batch volume for the zone. With this information, concierge system 140 generates 616 a batch availability score using a model trained on batch volumes for the retail location and, in some embodiments, batch volume for the zone. Additionally, the model used to generate the batch availability score can be further trained on historical wait times for pickers to receive a batch at the retail location and historical wait times for pickers to receive a batch in the zone. The model may also be further trained on a number of batches at a same time of day over a past week for the retail location and a number of batches at the same time of day over the past week for the zone.

Accordingly, concierge system 140 modifies 618 the map displayed by the client application to emphasize retail locations with a batch availability score above a threshold value. The batch availability score can be a numerical value reflecting batch availability or busyness of the retail location relative to other retail locations in the zone or can be a waiting time prediction in minutes corresponding to the predicted time the picker would need to wait at the retail location to receive a new batch. Accordingly, concierge system 140 modifies or adjusts how the retail locations appear on the map to encourage the picker to move towards busier retail locations where they are more likely to receive a batch sooner. Encouraging pickers to move or wait near busier retail locations reduces customer wait times by getting the customers their orders more quickly and benefits the pickers by providing them with more order deliveries per unit of time.

The concierge system, in one or more embodiments, modifies the appearance of retail locations displayed on the map by changing the color, such as displaying those retail locations with batch availability scores below the threshold in greyscale or in faded colors relative to those with batch availability scores above the threshold, as described with respect to FIG. 4. Alternatively, each retail location can be displayed with a number representing the predicted number of minutes until a batch becomes available adjacent to the retail location on the map, as described with respect to FIG. 5. Additionally, the concierge system, in one or more embodiments may provide a batch availability user interface element or toggle for display within the shopper client application that, when selected by a picker, causes retail locations with a batch availability score below the batch availability score threshold value to be hidden from view on the map, as described with respect to FIGS. 3A-3B. Thus, modifying the appearance of the retail locations displayed on the map, in one or more embodiments, includes removing retail locations with a batch availability score below the batch availability score threshold value, as discussed further below.

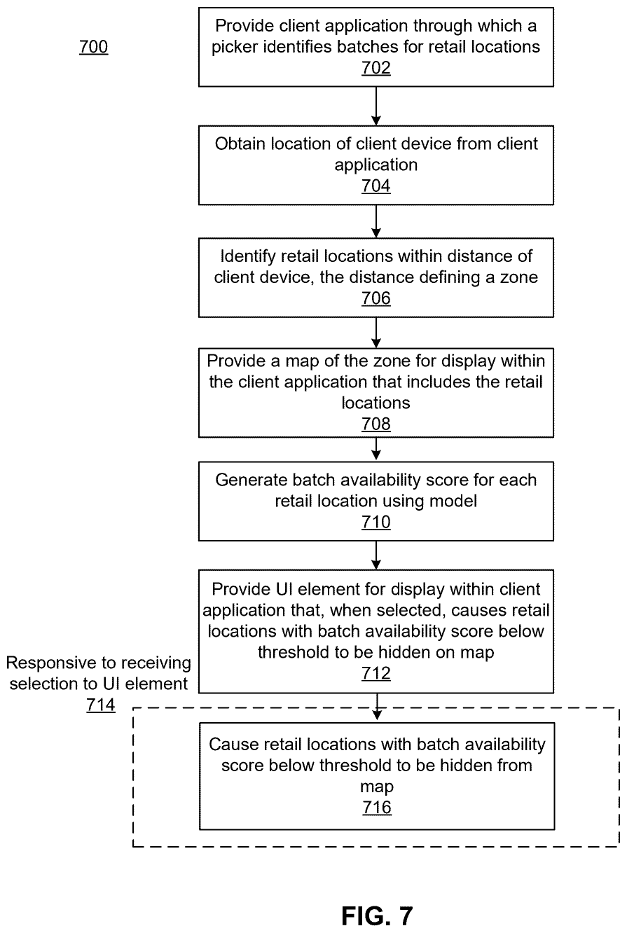

FIG. 7 is a flowchart for another method 700 of modifying a map to emphasize retail locations based on batch volume, in accordance with one or more embodiments. As above, alternative embodiments may include more, fewer, or different steps from those illustrated in FIG. 7, and the steps may be performed in a different order. Additionally, each of these steps may be performed automatically by the online concierge system without human intervention.

Concierge system 140 provides 702 a client application through which a picker can identify batches to fulfill for different retail locations from their client device and obtains 704 the location of client device from client application. From the location, concierge system 140 identifies 706 retail locations within a threshold distance of client device. The threshold distance from the location of the picker client device defines a zone. In various embodiments, the zone could encompass a predetermined distance from the client device, be associated with a commute time from the picker's current location or be associated with a current zoom level of the map.

Concierge system 140 provides 708 a map of the zone for display within the client application that includes the retail locations. Based on the size of the zone and the current zoon level from which the picker is viewing the map, only a subset of the retail locations may be simultaneously displayed.

Concierge system 140 generates 710 a batch availability score for each retail location using a model trained on inputs, such as batch volumes for the retail location and batch volume for the zone. As described above, the model used to generate the batch availability score can be further trained on historical wait times for pickers to receive a batch at the retail location and historical wait times for pickers to receive a batch in the zone, a number of batches at a same time of day over a past week for the retail location and a number of batches at the same time of day over the past week for the zone, among other inputs.

Accordingly, concierge system 140 provides 712 a batch availability user interface UI element for display within client application that, when selected, causes retail locations with batch availability score below threshold to be hidden from the map. The UI element can be a button or toggle and, in a default setting (e.g., when a picker opens the picker client application), provides all retail locations of the zone on the map for display. Thus, responsive to receiving 714 a selection to the batch availability UI element, concierge system 140 causes 716 retail locations with a batch availability score below the batch availability score threshold value to be hidden from view on the map displayed by the picker client application.

Thus, concierge system 140, in one or more embodiments, removes retail locations from the map that have batch availability scores below a batch availability score threshold value to encourage the picker to move towards busier retail locations. Encouraging pickers to move or wait near busier retail locations reduces customer wait times by getting the customers their orders more quickly and benefits the pickers by providing them with more order deliveries per unit of time.

In one or more embodiments, concierge system 140 tracks a number of retail locations visible on the map relative to a number of retail locations that are hidden in the zone to make sure there are a sufficient number of retail locations displayed on the map at any one time. To give providers options, the sufficient number may correspond to a default minimum number of retail locations for the zone as a whole; a set number of retail locations for a particular zoom level of the map (e.g., different zoom levels may corresponds to different minimum numbers of retail locations); a threshold number of retail locations within a particular distance or commute time of the picker Since some zones may have many retail locations and others may be limited, each of these examples, however, is dependent on the number of available retail locations in a zone. Thus, in response to determining that a ratio of visible to hidden retail locations is below a hidden-visible threshold, concierge system 140 can modify the batch availability score threshold value for hiding retail locations downward to ensure that a sufficient number of retail locations are visible on the map at a given time.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, the method comprising:
providing, by an online concierge system and to a picker client device, a picker client application through which a picker can identify batches to fulfill for a plurality of different retail locations;
obtaining, by the online concierge system and from the picker client application, a location of the picker client device;
identifying, by the online concierge system, a plurality of retail locations within a threshold distance of the location of the picker client device, wherein the threshold distance from the location of the picker client device defines a zone;
providing, by the online concierge system, a map of at least a portion of the zone for display within the picker client application, wherein the map includes at least a subset of the plurality of retail locations;
for each retail location in the zone over a past period of time:
determining a batch volume for the retail location;
determining an average batch volume for the zone; and
generating a batch availability score by inputting the batch volume for the retail location and the average batch volume for the zone into a model, wherein the model is trained on historical batch volumes for the retail location and historical batch volumes for the zone; and
modifying the map displayed by the picker client application to emphasize retail locations with a batch availability score above a batch availability score threshold value, wherein the modifying causes the picker client device to display the modified map.

2. The method of claim 1, wherein modifying the map comprises removing retail locations with a batch availability score below the batch availability score threshold value from the map displayed by the picker client application.

3. The method of claim 2, further comprising:
providing, by the online concierge system, a batch availability user interface element for display within the picker client application that, when selected by a picker, causes retail locations with a batch availability score below the batch availability score threshold value to be hidden from view on the map.

4. The method of claim 3, further comprising:
tracking a number of retail locations visible on the map relative a number of retail locations that are hidden in the zone; and
responsive to determining that a ratio of visible to hidden retail locations is below a hidden-visible threshold, modifying the batch availability score threshold value for hiding retail locations downward to ensure that a minimum number of available retail locations are visible on the map at a given time.

5. The method of claim 1, wherein generating the batch availability score comprises generating a numerical value reflecting busyness of the retail location relative to other retail locations in the zone.

6. The method of claim 1, wherein generating the batch availability score comprises generating a numerical value in minutes predicting a waiting time until the picker receives a batch at the retail location.

7. The method of claim 1, wherein modifying the map to emphasize retail locations with a batch availability score above the threshold value comprises modifying a color of retail locations with a batch availability score below the threshold value to appear faded or grey relative to retail locations with a batch availability score above the threshold value.

8. The method of claim 1, wherein the model used to generate the batch availability score is further trained on a number of batches at a same time of day over a past week for the retail location and a number of batches at the same time of day over the past week for the zone.

9. The method of claim 1, wherein the model used to generate the batch availability score is further trained on historical wait times for pickers to receive a batch at the retail location and historical wait times for pickers to receive a batch in the zone.

10. A non-transitory computer-readable medium storing instructions that, when executed by a processor, cause the processor to perform steps comprising:
providing, by an online concierge system and to a picker client device, a picker client application through which a picker can identify batches to fulfill for a plurality of different retail locations;
obtaining, by the online concierge system and from the picker client application, a location of the picker client device;
identifying, by the online concierge system, a plurality of retail locations within a threshold distance of the location of the picker client device, wherein the threshold distance from the location of the picker client device defines a zone;
providing, by the online concierge system, a map of at least a portion of the zone for display within the picker client application, wherein the map includes at least a subset of the plurality of retail locations;
for each retail location in the zone over a past period of time:
determining a batch volume for the retail location;
determining an average batch volume for the zone; and
generating a batch availability score by inputting the batch volume for the retail location and the average batch volume for the zone into a model, wherein the model is trained on historical batch volumes for the retail location and historical batch volumes for the zone; and
modifying the map displayed by the picker client application to emphasize retail locations with a batch availability score above a batch availability score threshold value, wherein the modifying causes the picker client device to display the modified map.

11. The computer-readable medium of claim 10, wherein modifying the map comprises removing retail locations with a batch availability score below the batch availability score threshold value from the map displayed by the picker client application.

12. The computer-readable medium of claim 11, wherein the computer-readable medium further stores instructions that, when executed by a processor, cause the processor to perform steps comprising:
providing, by the online concierge system, a batch availability user interface element for display within the picker client application that, when selected by a picker, causes retail locations with a batch availability score below the batch availability score threshold value to be hidden from view on the map.

13. The computer-readable medium of claim 12, wherein the computer-readable medium further stores instructions that, when executed by a processor, cause the processor to perform steps comprising:
tracking a number of retail locations visible on the map relative a number of retail locations that are hidden in the zone; and
responsive to determining that a ratio of visible to hidden retail locations is below a hidden-visible threshold, modifying the batch availability score threshold value for hiding retail locations downward to ensure that a minimum number of available retail locations are visible on the map at a given time.

14. The computer-readable medium of claim 10, wherein generating the batch availability score comprises generating a numerical value reflecting busyness of the retail location relative to other retail locations in the zone.

15. The computer-readable medium of claim 10, wherein generating the batch availability score comprises generating a numerical value in minutes predicting a waiting time until the picker receives a batch at the retail location.

16. The computer-readable medium of claim 10, wherein modifying the map to emphasize retail locations with a batch availability score above the threshold value comprises modifying a color of retail locations with a batch availability score below the threshold value to appear faded or grey relative to retail locations with a batch availability score above the threshold value.

17. The computer-readable medium of claim 10, wherein the model used to generate the batch availability score is further trained on a number of batches at a same time of day over a past week for the retail location and a number of batches at the same time of day over the past week for the zone.

18. The computer-readable medium of claim 10, wherein the model used to generate the batch availability score is further trained on historical wait times for pickers to receive a batch at the retail location and historical wait times for pickers to receive a batch in the zone.

19. A system comprising:
a processor; and
a non-transitory computer readable storage medium having instructions encoded thereon that, when executed by the processor, cause the processor to perform steps comprising:
providing, by an online concierge system and to a picker client device, a picker client application through which a picker can identify batches to fulfill for a plurality of different retail locations;
obtaining, by the online concierge system and from the picker client application, a location of the picker client device;
identifying, by the online concierge system, a plurality of retail locations within a threshold distance of the location of the picker client device, wherein the threshold distance from the location of the picker client device defines a zone;
providing, by the online concierge system, a map of at least a portion of the zone for display within the picker client application, wherein
the map includes at least a subset of the plurality of retail locations;
for each retail location in the zone over a past period of time:
determining a batch volume for the retail location;
determining an average batch volume for the zone; and
generating a batch availability score by inputting the batch volume for the retail location and the average batch volume for the zone into a model, wherein the model is trained on historical batch volumes for the retail location and historical batch volumes for the zone; and
modifying the map displayed by the picker client application to emphasize retail locations with a batch availability score above a batch availability score threshold value, wherein the modifying causes the picker client device to display the modified map.

20. The system of claim 19, wherein modifying the map comprises removing retail locations with a batch availability score below the batch availability score threshold value from the map displayed by the picker client application.
